(19) United States
(12) Patent Application Publication
(10) Pub. No.: US 2021/0206242 A1
(43) Pub. Date: Jul. 8, 2021

(54) VEHICLE DOOR MODULE

(71) Applicant: Inteva Products, LLC, Troy, MI (US)

(72) Inventors: Brian H. Staser, Oxford, MI (US); Ashley Simpson, Royal Oak, MI (US); Thomas Charles Sybrandy, Washington, MI (US)

(21) Appl. No.: 16/763,881

(22) PCT Filed: Nov. 21, 2018
(86) PCT No.: PCT/US2018/062192

§ 371 Date: May 13, 2020

Related U.S. Application Data
(60) Provisional application No. 62/592,777, filed on Nov. 30, 2017.

(51) Int. Cl. B60J 5/00; C08K 7/14; B32B 27/12; B32B 5/02; B32B 27/32; B32B 27/20; B32B 7/12

(52) U.S. Cl. CPC B60J 5/00; C08K 7/14; B32B 27/12; B32B 5/02; B32B 27/32; B29C 45/14631; B32B 7/12; B32B 2262/023; B32B 2262/0253; B32B 2605/00; B32B 2262/101; B32B 27/20

(57) ABSTRACT

A vehicle door module includes a textile overmolded with a first thermoplastic composition to form a unitary frame, wherein the textile includes reinforcing fibers and a second thermoplastic composition.

### BACKGROUND

Vehicle door modules are part of an integrated door assembly. The vehicle door module has attachment provisions for a number of components such as a window regulator, speaker and wire harness. The vehicle door module provides sufficient structural strength to support these components and to support their function.

Previously vehicle door modules were formed from metal, plastic, or a combination thereof. As there is an increasing need and desire to reduce overall vehicle weight, there is an increasing need and desire to reduce the weight of all vehicle components while maintaining the same functionality. Accordingly, there is a need and desire for a vehicle door module with decreased weight compared to previous vehicle door modules.

### BRIEF DESCRIPTION

Disclosed herein is a vehicle door module that includes a textile overmolded with a unitary frame comprising a first thermoplastic composition, wherein the textile includes reinforcing fibers and a second thermoplastic composition.

Also disclosed herein is a method of making the above described vehicle door module. The method includes molding a textile and overmolding the textile with a first thermoplastic composition to form a unitary frame wherein the textile includes reinforcing fibers and a second thermoplastic composition.

### BRIEF DESCRIPTION OF THE DRAWINGS

The following descriptions should not be considered limiting in any way. With reference to the accompanying drawings, like elements are numbered alike:

FIG. 1 depicts a vehicle door module having a textile overmolded with a unitary frame.

FIG. 2 depicts the obverse side of the vehicle door module shown in FIG. 1.

### DETAILED DESCRIPTION

A detailed description of one or more embodiments of the disclosed apparatus and method are presented herein by way of exemplification and not limitation with reference to the Figures.

The vehicle door module described herein is formed from a textile. The textile includes reinforcing fibers and a second thermoplastic composition. The textile is overmolded with a first thermoplastic composition to create a unitary frame. Overmolding with the first thermoplastic composition also provides attachment points for bayonet style connections, wire harnesses and the like. Overmolding can also form the housing for audio equipment as well as the necessary structure for window regulators.

The textile is formed of reinforcing fibers such as glass fiber, carbon fiber, aramid fiber, or a combination thereof. Exemplary weaves include a plain weave, a twill weave, a Dutch weave, a Dutch twill weave, a reverse Dutch weave, a reverse Dutch twill weave, or the like. The second thermoplastic composition may coat the reinforcing fibers (also known as a bicomponent fiber) or may be present in independent fibrous form. When in independent fibrous form the thermoplastic fibers may be part of the textile weave. The textile may be non-rigid prior to molding. Upon molding the second thermoplastic composition flows and connects at least a portion of the reinforcing fibers. In some embodiments the second thermoplastic composition flows between the reinforcing fibers and fills at least 75%, at least 85% or at least 95% of the gaps between the reinforcing fibers. The textile comprises 30 to 70 weight percent of the second thermoplastic composition, based on the total weight of the textile. Within this range the amount of the second thermoplastic composition can be 35 to 65 weight percent or 40 to 60 weight percent. The second thermoplastic composition may include a polyamide, a polyethylene, a polypropylene, a polyethylene copolymer, a polypropylene copolymer, or a combination thereof.

The vehicle door module can comprise a single layer of the textile or multiple layers of the textile. In some embodiments the vehicle door module comprises a single layer of the textile in some areas and multiple layers in other areas. Multiple layers may be employed in areas requiring more rigidity or strength. When multiple layers are employed they may be adhered together at least temporarily prior to molding to facilitate the molding process.

The first thermoplastic composition may include a polyamide, a polyethylene, a polypropylene, a polyethylene copolymer, a polypropylene copolymer, or a combination thereof. In some embodiments the first thermoplastic composition is chemically similar to the second thermoplastic composition used in the textile. For example, if the second thermoplastic composition includes a polyethylene then the first thermoplastic composition may include a polyethylene or a polyethylene copolymer. In some embodiments both thermoplastic compositions comprise polypropylene.

The first thermoplastic composition may further comprise one or more reinforcing fillers. Exemplary reinforcing fillers include glass fiber, carbon fiber, carbon fibrils, wollastonite, and combinations thereof. The glass fiber and carbon fiber may be discontinuous chopped fiber. When the reinforcing filler is present it may be used in an amount of 10 to 60 weight percent, or, 25 to 40 weight percent, based on the total weight of the unitary frame. The first thermoplastic composition may also comprise an additive such as a pigment or dye.

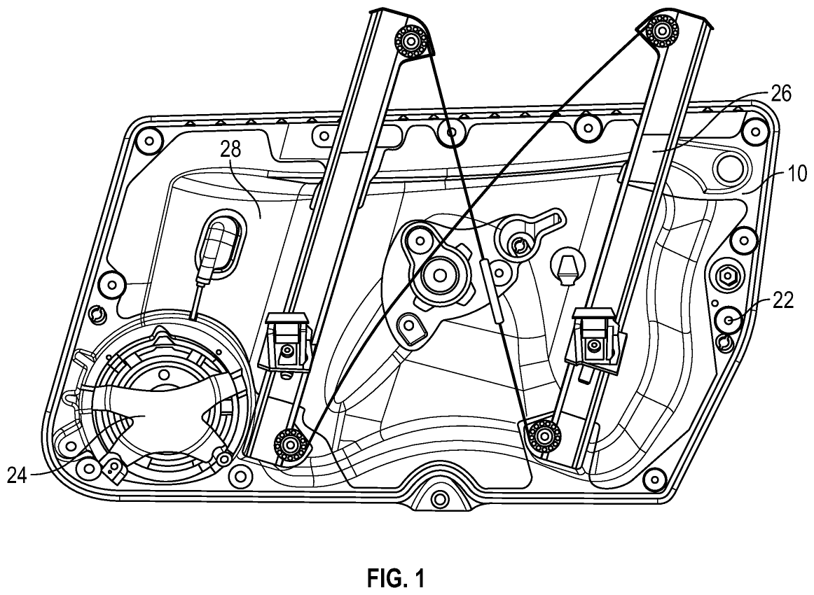

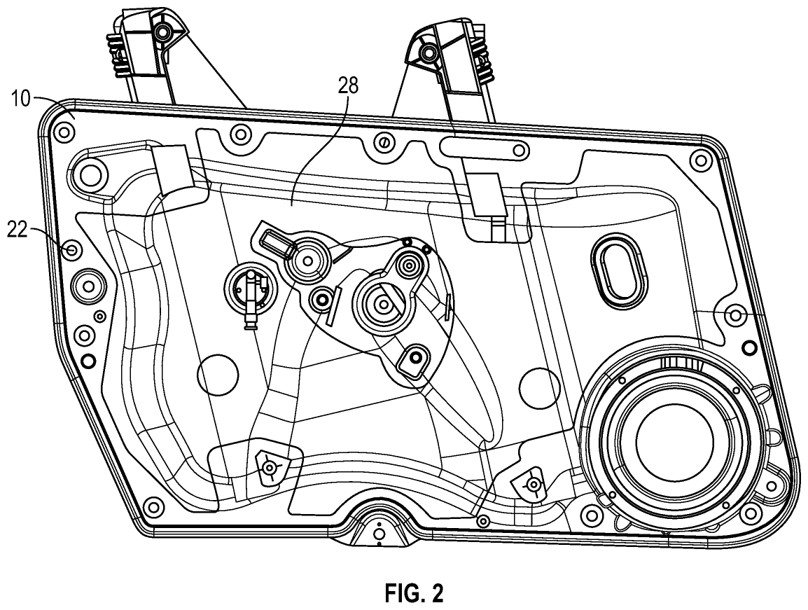

FIG. 1 shows the unitary frame 10, formed from the first thermoplastic composition. The unitary frame has through holes, 22, for attachment of other portions of the door assembly, and a location, 24, for an audio speaker. FIG. 1 shows a window regulator, 26, with integrated rails but it is also contemplated that any window regulator system could be used. The textile 28 is located within the boundaries of the unitary frame 10. The textile can also bridge across some areas of the unitary frame. In some embodiments the textile overlaps at least 75% of the area of the unitary frame. In some embodiments the textile overlaps at least 85% of the unitary frame. In some embodiments the textile overlaps 100% of the unitary frame. Some areas of the door module may consist of the textile. FIG. 2 shows the obverse of the vehicle door module shown in FIG. 1.

The adhesion between the unitary frame and the textile may be promoted or provided through the use of an adhesive material, a compatibilizing interlayer, or a surface treatment. Exemplary surface treatments include flame treating and plasma treating. Exemplary adhesives include acrylic based adhesives. Exemplary compatibilizing interlayers include polymers known to be compatible with both the unitary frame and the textile. For example, when the unitary frame comprises polypropylene and the textile comprises polystyrene the compatibilizing interlayer may comprise a polypropylene-polystyrene copolymer. In some embodiments, the thermoplastic polymer in the textile and the first thermoplastic composition are compatible and no adhesive, compatibilizing interlayer, or surface treatment is required. For example, when the unitary frame comprises polypropylene and the textile comprises a polypropylene no adhesive, interlayer, or surface treatment is required.

The textile may be placed in the tool and the unitary frame overmolded onto the textile. In some embodiments the unitary frame is overmolded on portions of a single side of the textile and in some embodiments the unitary frame is overmolded onto portions of both sides of the textile. In either case there are areas of the door module that consist of the textile and are bounded by the unitary frame. In some embodiments the textile is heated prior to placing it in the tool. In some embodiments the textile is heated in the tool prior to or simultaneous with overmolding. The textile may be coated with or impregnated with an adhesive to promote adhesion to the unitary frame prior to overmolding. A closed cell polymeric foam may be used to form a sealing edge at the periphery of the vehicle door module.

In a second approach the textile is compression molded with the unitary frame. In this approach, the thermoplastic textile and unitary frame are placed in a tool and compression molded.

In any of the foregoing methods the molding temperatures, times and pressures will be determined by the materials employed and can be determined by a man of skill in the art. As would be understood by one of skill in the art the textile must attain a temperature sufficient to allow the second thermoplastic composition flow and disperse through at least a portion of the reinforcing fibers.

This disclosure further encompasses the following embodiments.

Embodiment 1: A vehicle door module comprising a textile overmolded with a unitary frame comprising a first thermoplastic composition, wherein the textile comprises reinforcing fibers and a second thermoplastic composition.

Embodiment 2: The vehicle door module of Embodiment 1, wherein the first thermoplastic composition comprises polypropylene and glass fiber.

Embodiment 3: The vehicle door module of Embodiment 1 or 2, wherein the first thermoplastic compositions comprises glass fiber in an amount of 10 to 60 weight percent, based on the total weight of the unitary frame.

Embodiment 4: The vehicle door module of any one of Embodiments 1 to 3, wherein the textile comprises 30 to 70 weight percent of the second thermoplastic composition, based on the total weight of the textile.

Embodiment 5: The vehicle door module of any one of the preceding Embodiments, wherein the textile comprises glass fiber and a thermoplastic polymer comprising a polyamide, a polyethylene, a polypropylene, a polyethylene copolymer, a polypropylene copolymer, or a combination thereof.

Embodiment 6: The vehicle door module of any one of the preceding Embodiments, further comprising a perimeter seal.

Embodiment 7: The vehicle door module of any of the preceding Embodiments further comprising an adhesive disposed between a portion of the unitary frame and a portion of the textile.

Embodiment 8: A method of making a vehicle door module comprising molding a textile and overmolding a unitary frame comprising a first thermoplastic composition onto the textile, wherein the textile comprises reinforcing fibers and a second thermoplastic composition.

Embodiment 9: The method of Embodiment 8, wherein the unitary frame comprises polypropylene and glass fiber and the textile comprises polypropylene and glass fiber.

Embodiment 10: The method of Embodiment 8 or 9, further comprising surface treating the textile prior to overmolding.

Embodiment 11: The method of any one of Embodiments 8 to 10, further comprising applying an adhesive to the textile prior to overmolding.

Embodiment 12: The method of any one of Embodiments 8 to 12, wherein the unitary frame comprises polypropylene and glass fiber.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A vehicle door module comprising a textile overmolded with a unitary frame comprising a first thermoplastic composition, wherein the textile comprises reinforcing fibers and a second thermoplastic composition.

2. The vehicle door module of claim 1, wherein the first thermoplastic composition comprises polypropylene and glass fiber.

3. The vehicle door module of claim 1, wherein the first thermoplastic compositions comprises glass fiber in an amount of 10 to 60 weight percent, based on the total weight of the unitary frame.

4. The vehicle door module of claim 1, wherein the textile comprises 30 to 70 weight percent of the second thermoplastic composition, based on the total weight of the textile.

5. The vehicle door module of claim 1, wherein the textile comprises glass fiber and a thermoplastic polymer comprising a polyamide, a polyethylene, a polypropylene, a polyethylene copolymer, a polypropylene copolymer, or a combination thereof.

6. The vehicle door module of claim 1, further comprising a perimeter seal.

7. The vehicle door module of claim 1 further comprising an adhesive disposed between a portion of the unitary frame and a portion of the textile.

8. A method of making a vehicle door module comprising molding a textile and overmolding a unitary frame comprising a first thermoplastic composition onto the textile, wherein the textile comprises reinforcing fibers and a second thermoplastic composition.

9. The method of claim 8, wherein the unitary frame comprises polypropylene and glass fiber and the textile comprises polypropylene and glass fiber.

10. The method of claim 8, further comprising surface treating the textile prior to overmolding.

11. The method of claim 8, further comprising applying an adhesive to the textile prior to overmolding.

12. The method of claim 8, wherein the unitary frame comprises polypropylene and glass fiber.
